(19) United States
(12) Patent Application Publication
(10) Pub. No.: US 2020/0193003 A1
(43) Pub. Date: Jun. 18, 2020

(54) ACCESS LEVEL BASED ON STRESS DETERMINATION

(71) Applicant: International Business Machines Corporation, Armonk, NY (US)

(72) Inventors: Denise Bell, Austin, TX (US); Jeffrey A. Kusnitz, Campbell, CA (US); Jana H. Jenkins, Raleigh, NC (US)

(21) Appl. No.: 16/218,932

(22) Filed: Dec. 13, 2018

(51) Int. Cl. G06F 21/32; G06F 21/31; G06F 21/40; G06F 21/62

(52) U.S. Cl. CPC G06F 21/32; G06F 21/62; G06F 21/40; G06F 21/316

(57) ABSTRACT

Switching access configurations of a computing device when receiving an indication of a personal security concern. The computing device is configured with a first mode having a first level of access and a second mode having a second level of access. The first level of access permits full access to the computing device and the second level of access restricts access to the computing device. In response to receiving the indication of the personal security concern, the computing device switches from the first level of access to the second level of access.

### BACKGROUND

The invention relates generally to how computing devices are accessed and, more particularly, relates to granting a different level of access upon receiving a personal security concern from an authorized user.

Computing devices such as laptops and mobile phones are nearly ubiquitous. Moreover, the information stored on these devices ranges from the mundane to the highly sensitive. Originally, access to these devices was granted simply by entering a password. More recently, access is granted to these devices by using a fingerprint identity sensor or facial recognition. However, sometimes someone may want additional security when entering a password. What is needed is a way to provide an additional layer of security by limiting access to your computing device when detecting the user is concerned about personal security.

### SUMMARY

According to a non-limiting embodiment, a method for switching access configurations of a computing device is provided. The method includes configuring the computing device to permit a first level of access when in a first mode and configuring the computing device to permit a second level of access when in a second mode, wherein the second level of access restricts access to the computing device and the first level of access permits greater access to the computing device than the second level of access. The method also includes receiving an indication of a personal security concern from an authorized user of the computing device and, in response to receiving the indication of a personal security concern, switching from the first level of access to the second level of access. The method may include receiving biometric information as the indication of a personal security concern and the biometric information may be a galvanic skin response.

According to another non-limiting embodiment, a system for granting permissions for accessing a computing device is provided. The system includes a processor coupled to a memory unit, wherein the processor is configured to execute program instructions. The program instructions include configuring the computing device to permit a first level of access when in a first mode and configuring the computing device to permit a second level of access when in a second mode, wherein the second level of access restricts access to the computing device and the first level of access permits greater access to the computing device than the second level of access. The program instructions also include receiving an indication of a personal security concern from an authorized user of the computing device and, in response to receiving the indication of a personal security concern, switching from the first level of access to the second level of access. The program instructions may include receiving biometric information and the biometric information may be a galvanic skin response from at least one galvanic skin response sensor of the computing device.

According to yet another non-limiting embodiment, a computer program product is provided. The computer program product includes a computer readable storage medium having program instructions embodied therewith, the program instructions executable by a computer processor to cause the computer processor to perform a method for granting permissions for accessing a computing device. The method includes configuring the computing device to permit a first level of access when in a first mode and configuring the computing device to permit a second level of access when in a second mode, wherein the second level of access restricts access to the computing device and the first level of access permits greater access to the computing device than the second level of access. The method also includes receiving an indication of a personal security concern from an authorized user of the computing device and, in response to receiving the indication of a personal security concern, switching from the first level of access to the second level of access. The method may include receiving a galvanic skin response indicating the authorized user has a personal security concern.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 depicts a block diagram illustrating an exemplary computing device that may be utilized to implement one or more embodiments of the present invention;

FIG. 2 depicts a block diagram illustrating an exemplary mobile computing device that may be utilized to implement one or more embodiments of the present invention;

FIG. 3 depicts a block diagram illustrating components of an exemplary mobile computing device that may be utilized to implement one or more embodiments of the present invention; and

FIG. 4 is a flow diagram illustrating a method for switching access configurations of a computing device according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

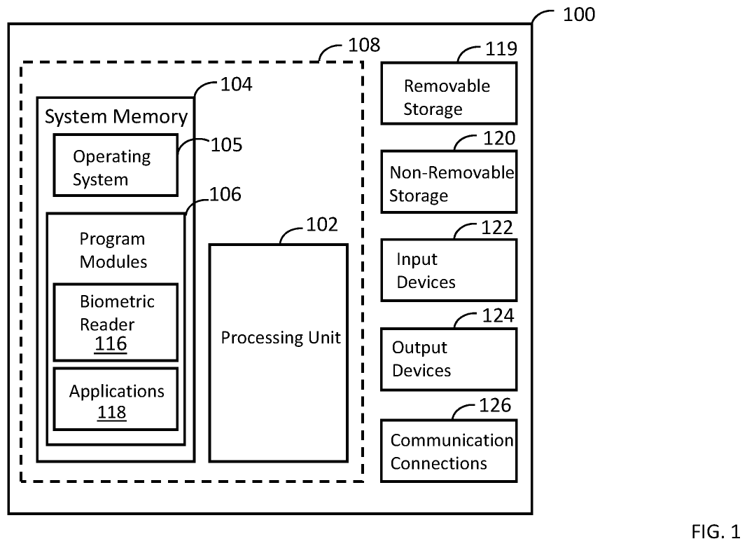

FIGS. 1-3 and the associated descriptions provide a description of various operating environments in which examples of the disclosure are practiced. However, FIGS. 1-3 are for purposes of example and illustration and are not limiting of the vast number of computing device configurations that are utilized for practicing aspects of the disclosure.

Referring to FIG. 1, there is shown an embodiment illustrating physical components (i.e., hardware) of a processing system, commonly referred to as a computing device or system 100, for implementing the teachings herein. In a basic configuration, the computing device 100 includes at least one processing unit 102 and a system memory 104. According to an aspect, depending on the configuration and type of computing device, the system memory 104 comprises, but is not limited to, volatile storage (e.g., random access memory), non-volatile storage (e.g., read-only memory), flash memory, or any combination of such memories. According to an aspect, the system memory 104 includes an operating system 105 and one or more program modules 106 suitable for running software applications 118. According to an aspect, the system memory 104 includes the biometric reader 116. The operating system 105, for example, is suitable for controlling the operation of the computing device 100.

Furthermore, aspects are practiced in conjunction with a graphics library, other operating systems, or any other application program, and is not limited to any particular application or system. This basic configuration is illustrated in FIG. 1 by those components within a dashed line 108. According to an aspect, the computing device 100 has additional features or functionality. For example, according to an aspect, the computing device 100 includes additional data storage devices (removable and/or non-removable) such as, for example, magnetic disks, optical disks, or tape. Such additional storage is illustrated in FIG. 1 by a removable storage device 119 and a non-removable storage device 120.

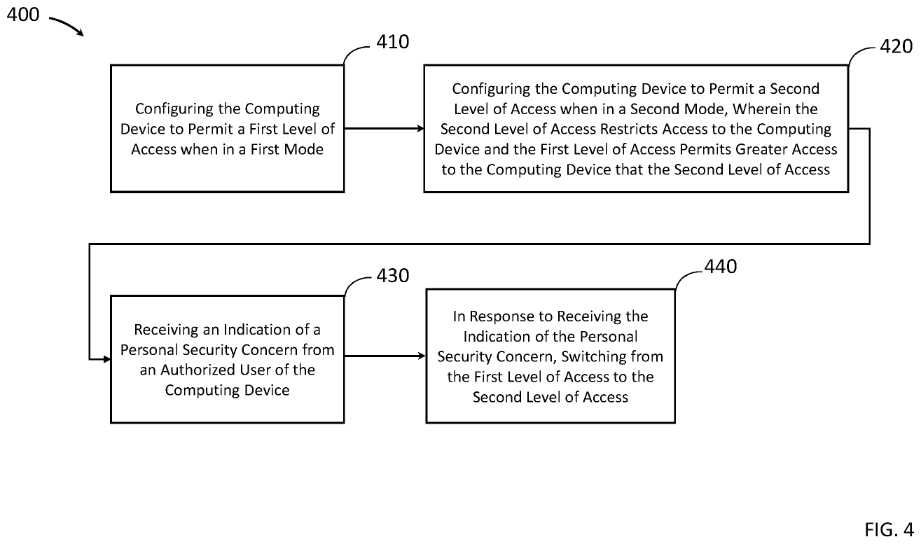

As stated above, according to an aspect, a number of program modules and data files are stored in the system memory 104. While executing on the processing unit 102, the program modules 106 (e.g., biometric reader 116) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, and the like.

According to an aspect, the computing device 100 has one or more input device(s) 122 such as a keyboard, a mouse, a pen, a sound input device, a touch input device, etc. The output device(s) 124 such as a display, speakers, a printer, etc. are also included according to an aspect. The aforementioned devices are examples and others may be used. For example, the computing device may include one or more biometric sensors as described in greater detail below. According to an aspect, the computing device 100 includes one or more communication connections 126 allowing communications with other computing devices. Examples of suitable communication connections 126 include, but are not limited to, radio frequency (RF) transmitter, receiver, and/or transceiver circuitry; universal serial bus (USB), parallel, and/or serial ports.

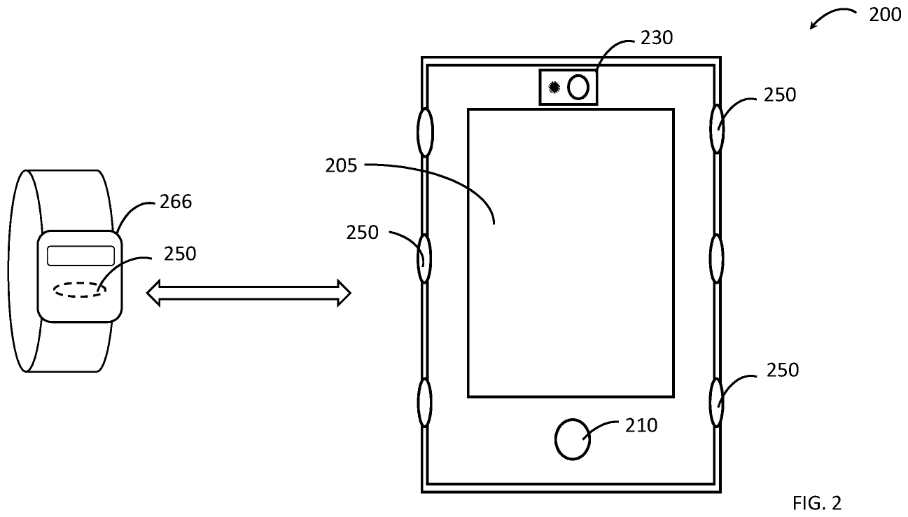

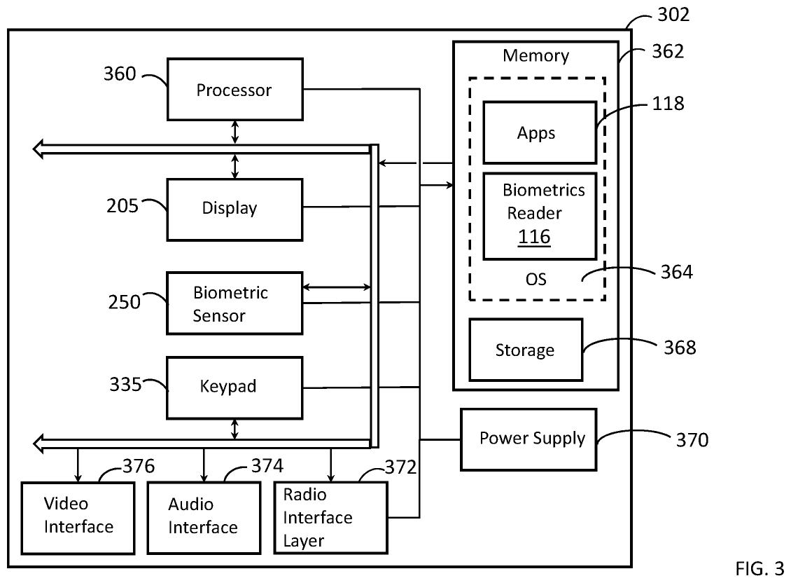

FIGS. 2 and 3 illustrate a mobile computing device 200, for example, a mobile telephone, a smartphone, a tablet personal computer, a laptop computer, and the like, with which aspects may be practiced. In a basic configuration, the mobile computing device 200 is a handheld computer having both input elements and output elements. The mobile computing device 200 typically includes a display 205 and one or more input or home buttons 210 that allow the user to navigate information and between an application on the mobile computing device 200. According to an aspect, the display 205 of the mobile computing device 200 functions as an input device (e.g., a touchscreen display). In alternative examples, mobile computing device 200 incorporates more or less input elements. The mobile computing device 200 may also include a keypad 335 (FIG. 3) such as a soft keypad generated via the display 205. According to an aspect, the optional keypad may be a physical keypad. Also, in one or more embodiments, the mobile computing device may include a camera 230.

FIG. 3 is a block diagram illustrating the architecture of one example of a mobile computing device. That is, the mobile computing device 200 incorporates a system (i.e., an architecture) 302 to implement some examples. In one example, the system 302 is implemented as a “smart phone” capable of running one or more applications (e.g., browser, e-mail, calendaring, contact managers, messaging clients, games, and media clients/players). In some examples, the system 302 is integrated as a computing device, such as an integrated personal digital assistant (PDA) and wireless phone.

According to an aspect, one or more application programs 118 are loaded into the memory 362 and run on or in association with the operating system 364. Examples of application programs include phone dialer programs, e-mail programs, personal information management (PIM) programs, word processing programs, spreadsheet programs, Internet browser programs, messaging programs, and so forth. According to an aspect, the application for biometrics reader 116 is loaded into memory 362. The system 302 also includes a non-volatile storage area 368 within the memory 362. The non-volatile storage area 368 is used to store persistent information that should not be lost if the system 302 is powered down. The application programs 118 may use and store information in the non-volatile storage area 368, such as e-mail or other messages used by an e-mail application, and the like. A synchronization application (not shown) also resides on the system 302 and is programmed to interact with a corresponding synchronization application resident on a host computer to keep the information stored in the non-volatile storage area 368 synchronized with corresponding information stored at the host computer. As should be appreciated, other applications may be loaded into the memory 362 and run on the mobile computing device 200.

According to an aspect, the system 302 has a power supply 370, which is implemented as one or more batteries. According to an aspect, the power supply 370 further includes an external power source, such as an AC adapter or a powered docking cradle that supplements or recharges the batteries.

According to an aspect, the system 302 includes a radio 372 that performs the function of transmitting and receiving radio frequency communications. The radio 372 facilitates wireless connectivity between the system 302 and the “outside world,” via a communications carrier or service provider. Transmissions to and from the radio 372 are conducted under control of the operating system 364. In other words, communications received by the radio 372 may be disseminated to the application programs 118 via the operating system 364, and vice versa.

These devices may be directly coupled to the power supply 370 so that when activated, they remain on for a duration dictated by the notification mechanism even though the processor 360 and other components might shut down for conserving battery power. The LED may be programmed to remain on indefinitely until the user takes action to indicate the powered-on status of the device. The audio interface 374 is used to provide audible signals to and receive audible signals from the user. For example, the audio interface 374 may also be coupled to a microphone to receive audible input such as to facilitate a telephone conversation. According to an aspect, the system 302 further includes a video interface 376 that enables an operation of the on-board camera 230 to record still images, video stream, and the like.

According to an aspect, a mobile computing device 200 implementing the system 302 has additional features or functionality. For example, the mobile computing device 200 includes additional data storage devices (removable and/or non-removable) such as, magnetic disks, optical disks, or tape. Such additional storage is illustrated in FIG. 3 by the non-volatile storage area 368.

The system 302 also includes one or more biometric sensors 250 working in conjunction with the biometric reader 116. The biometric sensor 250 is capable of physiological and behavioral biometrics identifying a user's physical and behavioural characteristics. Biometric sensors 250 can be used to detect the existence of a personal security concern while a user is accessing the computing device 100, 200 with face identification, fingerprints, hand geometry, voice pattern, iris pattern, or combinations thereof, for example. In one or more embodiments, the biometric sensor 250 detects the input of the characteristic to be used for identification and stores it on the computing device. The biometric reader 116 analyzes the input characteristic, translates it into a graph or code, and performs comparisons. A comparison can then indicate whether a user is concerned or not. In one or more embodiments, the input also includes a galvanic skin response along with the characteristics used for identification for accessing the computing device.

In one or more embodiments, the mobile computing device 200 may include a plurality of biometric sensors 250 spaced around the periphery of the computing device 200. One or more of the biometric sensors 250 can be galvanic skin response detectors to then detect a galvanic skin response. In such case, the biometric sensors 250 may be used by themselves or in combination with the home button 210. In one embodiment, the computing device 200 may be connected or paired, for example wirelessly, with another computing device 266 configured as a wearable device such as a watch, for example. In such case, one or more biometric sensors 250 for detecting responses may be incorporated into the computing device 266 and the responses transmitted to the computing device 200.

In one or more other embodiments, the biometric sensor may instead be a camera such as the camera 230 of the mobile computing device 200 or a camera on the computing device 100. In such case, one or more images from the camera 230 are compared via a facial identification feature of the biometric reader 116 with stored images which are used to determine whether or not the facial identification received as input indicates the user is concerned about personal security when accessing the mobile computing device 200. In one or more other embodiments, the biometric sensor 250 can be the home button 210 itself and upon the user accessing the computing device with a fingerprint the biometric reader 116 may use a galvanic skin response to determine that the user is under duress. In one or more other embodiments, the display 205 may be a touchscreen capable of receiving galvanic skin responses. In such case, when a user uses the touchscreen to access the computing device, such as entering a passcode, a detected galvanic skin response could be received and determined to indicate a personal security concern while accessing the computing device.

In one or more embodiments, the computing device 100, 200 is configured by the user to have different modes where each mode corresponds with a different level of access. The authorized user determines what information is permitted to be accessible via the computing device 100, 200 under normal conditions versus when under concerned about personal security. For example, in a first mode with a first level of access all of the information that is stored on or is accessible by the computing device 100, 200 is available upon the authorized user accessing the computing device 100, 200. In contrast, in another or second mode with a second level of access only a portion of the information stored or accessible by the computing device 100, 200 is available upon the authorized user accessing the computing device 100, 200. In one or more embodiments, in the first mode having the first level of access all the information, including information the user has indicated as confidential information, is accessible to the authorized user and in the second mode having the second level of access the authorized user's access is restricted to information other than the information the user has indicated as confidential information. In other words, in the second mode access to the confidential information is precluded. Thus, when an authorized user is concerned about personal security, based on the input received from the authorized user, the computing device switches itself or limits itself to the second mode with the second or restricted level of access. In one or more embodiments, access to one or more messages, photos, videos, search history, browser history, navigation or location history, or applications, for example, could be restricted by obscuring them from view or preventing them from being opened, displayed or downloaded, etc. Also, to the extent information could be available over a network via the computing device 100, 200, one or modes configured by the authorized user could permit or restrict access to such information. For example, information accessible via a webpage may be permitted or precluded when under a personal security concern exists.

Turning to FIG. 4, one or more embodiments may include a method 400 for switching access configurations of a computing device 100, 200. The flow diagram of FIG. 4 illustrates the method 400 that includes process block 410 for configuring the computing device to permit a first level of access when in a first mode and process block 420 for configuring the computing device to permit a second level of access when in a second mode, wherein the second level of access restricts access to the computing device and the first level of access permits greater access to the computing device than the second level of access. The method 400 also includes process block 430 for receiving an indication of a personal security concern from an authorized user of the computing device. Also, the method 400 includes switching from the first level of access to the second level of access in response to receiving the indication of a personal security concern, as shown at process block 440.

The method 400 may include receiving biometric information as the input indicating the authorized user has a personal security concern. Also, the method may include receiving a galvanic skin response as the biometric information.

Various technical benefits are achieved using the system and methods described herein, including the capability of providing enhanced performance for applications with exclusive access to the co-processors while also allowing applications that do not need performance when shared access is available. In this manner, the computing device can realize performance gains through the use of co-processors in the system, thereby improving overall processing speeds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for switching access configurations of a computing device, the method comprising:
configuring the computing device to permit a first level of access when in a first mode;
configuring the computing device to permit a second level of access when in a second mode, wherein the second level of access restricts access to the computing device and the first level of access permits greater access to the computing device than the second level of access;
receiving an indication of a personal security concern from an authorized user of the computing device; and
in response to receiving the indication of a personal security concern, switching from the first level of access to the second level of access.

2. The method of claim 1 wherein receiving an indication of a personal security concern comprises receiving biometric information from the authorized user.

3. The method of claim 2 wherein receiving biometric information comprises receiving a galvanic skin response.

4. The method of claim 3 wherein the galvanic skin response is received via a touchscreen of the computing device.

5. The method of claim 3 wherein the galvanic skin response is received via a home button of the computing device.

6. The method of claim 3 wherein the galvanic skin response is received via a plurality of galvanic skin response sensors of the computing device.

7. The method of claim 2 wherein receiving biometric information comprises receiving a facial identification.

8. The method of claim 1 wherein configuring the computing device to permit a first level of access when in a first mode comprises permitting access to all information via the computing device.

9. The method of claim 1 wherein configuring the computing device to permit a first level of access when in a first mode comprises permitting access to information via the computing device that the authorized user has indicated as confidential.

10. The method of claim 1 wherein configuring the computing device to permit a second level of access when in a second mode comprises precluding access to information via the computing device the authorized user has indicated as confidential.

11. The method of claim 10 wherein access to information available via a web page is precluded.

12. A system for granting permissions for accessing a computing device, the system comprising:
a processor coupled to a memory unit, wherein the processor is configured to execute program instructions comprising:
configuring the computing device to permit a first level of access when in a first mode;
configuring the computing device to permit a second level of access when in a second mode, wherein the second level of access restricts access to the computing device and the first level of access permits greater access to the computing device than the second level of access;
receiving an indication of a personal security concern from an authorized user of the computing device; and
in response to receiving the indication of a personal security concern, switching from the first level of access to the second level of access.

13. The system of claim 12 wherein receiving an indication of a personal security concern comprises receiving biometric information from the authorized user.

14. The system of claim 12 wherein receiving biometric information comprises receiving a galvanic skin response.

15. The system of claim 14 wherein the galvanic skin response is received via at least one galvanic skin response sensor of the computing device.

16. The system of claim 12 wherein receiving biometric information comprises receiving a facial identification.

17. The system of claim 12 wherein configuring the computing device to permit a first level of access when in a first mode comprises permitting access to all information via the computing device, and wherein configuring the computing device to permit a second level of access when in a second mode comprises precluding access to information via the computing device the authorized user has indicated as confidential.

18. A computer program product comprising a computer readable storage medium having program instructions embodied therewith, the program instructions executable by a computer processor to cause the computer processor to perform a method for granting permissions for accessing a computing device, comprising:
configuring the computing device to permit a first level of access when in a first mode;
configuring the computing device to permit a second level of access when in a second mode, wherein the second level of access restricts access to the computing device and the first level of access permits greater access to the computing device than the second level of access;
receiving an indication of a personal security concern from an authorized user of the computing device; and
in response to receiving the personal security concern, switching from the first level of access to the second level of access.

19. The computer program product of claim 18 wherein receiving an indication of a personal security concern comprises receiving biometric information, and wherein the biometric information comprises receiving a galvanic skin response.

20. The computer program product of claim 18 wherein configuring the computing device to permit a first level of access when in a first mode comprises permitting access to all information via the computing device, and wherein configuring the computing device to permit a second level of access when in a second mode comprises precluding access to information via the computing device the authorized user has indicated as confidential.
